(19) United States
(12) Patent Application Publication
(10) Pub. No.: US 2023/0226552 A1
(43) Pub. Date: Jul. 20, 2023

(54) DRY REAGENT CUP ASSEMBLIES AND METHODS

(71) Applicant: ILLUMINA, INC., San Diego, CA (US)

(72) Inventors: Travis Beckman, San Diego, CA (US); Paul Crivelli, San Diego, CA (US); Wesley Cox-Muranami, Middleton, WI (US); Jennifer Foley, San Diego, CA (US); Darren Segale, San Diego, CA (US); Allison Duchnak, Escondido, CA (US); Keith Frankie, San Diego, CA (US); Cameron Mar, San Diego, CA (US)

(21) Appl. No.: 18/009,545

(22) PCT Filed: May 24, 2021
(86) PCT No.: PCT/US2021/033879

§ 371 Date: Dec. 9, 2022

Related U.S. Application Data
(60) Provisional application No. 63/043,623, filed on Jun. 24, 2020.

(51) Int. Cl. B01L 3/00

(52) U.S. Cl. CPC B01L 3/523; B01L 2200/16; B01L 2300/044; B01L 2300/0672; B01L 2200/025

(57) ABSTRACT

Dry reagent cup assemblies and methods are disclosed. In accordance with an implementation, an apparatus includes a liquid reservoir and dry reagent cup assembly. The liquid reservoir has a base, side wall that extends from the base, and distal opening. The dry reagent cup assembly coupled to the liquid reservoir includes a dry reagent cup and liquid impermeable barrier. The dry reagent cup has a cup base, cup side wall that extends from the cup base, and cup opening. The distal opening of the liquid reservoir faces the cup opening. The liquid impermeable barrier covers the cup opening and separates the liquid reservoir and the dry reagent cup. The dry reagent cup moves between an initial position outside the liquid reservoir and a rehydrating position where the dry reagent cup pierces and passes through an opening in the liquid impermeable barrier and is received within the liquid reservoir.

### BACKGROUND

This application claims the benefit of and priority to U.S. Provisional Patent Application No. 62/043,623, filed Jun. 24, 2020, the content of which is incorporated by reference herein in its entirety and for all purposes.

### RELATED APPLICATION SECTION

Reagent cartridges used with, for example, sequencing platforms, may include liquid reagent that is kept frozen until use. Keeping the reagent frozen may involve using additional packaging and/or dry ice when transporting the reagent and may involve keeping the reagent within a freezer at a facility. The measures taken to keep the reagent frozen can raise the cost of shipping and may cause some facilities to purchase additional or larger freezers or other equipment to store the reagent cartridges. Moreover, the use of ice packs, dry ice, and/or additional packaging when shipping frozen reagent may reduce sustainability and increase waste.

### SUMMARY

Shortcomings of the prior art can be overcome and benefits as described later in this disclosure can be achieved through the provision of dry reagent cup assemblies and related methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

The disclosed examples relate to reagent cartridges including dry reagent that have increased shelf life and stability as compared to liquid reagent and may be shipped and stored at ambient temperature. Thus, the disclosed reagent cartridges may be shipped and stored at less cost and may not be required to be stored in a freezer. The dry reagent may also be rehydrated on demand during or prior to, for example, a sequencing operation.

In accordance with a first implementation, an apparatus includes a liquid reservoir and a dry reagent cup assembly. The liquid reservoir has a base, a side wall that extends from the base, and a distal opening. The dry reagent cup assembly is coupled to the liquid reservoir and includes a dry reagent cup and a liquid impermeable barrier. The dry reagent cup has a cup base, a cup side wall that extends from the cup base, and a cup opening. The distal opening of the liquid reservoir faces the cup opening. The liquid impermeable barrier covers the cup opening and separates the liquid reservoir and the dry reagent cup. The dry reagent cup is movable between an initial position outside of the liquid reservoir and a rehydrating position where the dry reagent cup pierces and passes through an opening in the liquid impermeable barrier and is received within the liquid reservoir.

In accordance with a second implementation, an apparatus includes a dry reagent cup assembly including a dry reagent cup and a liquid impermeable barrier. The dry reagent cup contains dry reagent and has a cup base and a cup side wall that extends from the cup base, and a cup opening. The liquid impermeable barrier covers the cup opening. The dry reagent cup is movable to pierce the liquid impermeable barrier and allow the dry reagent cup to pass through the liquid impermeable barrier.

In accordance with a third implementation, a method includes piercing a liquid impermeable barrier of a reagent reservoir with an asymmetrical protrusion of a dry reagent cup. The dry reagent cup contains dry reagent and has a cup opening facing the liquid impermeable barrier and an opening of a liquid reservoir containing liquid. The method also includes moving the dry reagent cup into the liquid reservoir to rehydrate the dry reagent and form liquid reagent.

In accordance with a fourth implementation, an apparatus includes a system, a flow cell assembly, and a reagent cartridge. The system includes a reagent cartridge receptacle and the reagent cartridge includes a plurality of reagent reservoirs. One or more of the reagent reservoirs includes a liquid reservoir and a dry reagent cup assembly including a dry reagent cup and a liquid impermeable barrier. The liquid reservoir has a base, a side wall that extends from the base, and a distal opening. The dry reagent cup assembly is coupled to the liquid reservoir and has a cup base, a cup side wall that extends from the cup base, and a cup opening. The distal opening of the liquid reservoir faces the cup opening and the liquid impermeable barrier covers the cup opening and separates the liquid reservoir and the dry reagent cup. The dry reagent cup is movable between an initial position outside of the liquid reservoir and a rehydrating position where the dry reagent cup pierces and passes through an opening in the liquid impermeable barrier and is received within the liquid reservoir.

In accordance with a fifth implementation, a method includes piercing a liquid impermeable barrier of a reagent reservoir with a plurality of protrusions of a dry reagent cup, where the protrusions are asymmetrically distributed about the cup, the dry reagent cup contains dry reagent and has a cup opening facing the liquid impermeable barrier and an opening of a liquid reservoir containing liquid. The method also includes moving the dry reagent cup into the liquid reservoir to rehydrate the dry reagent and form liquid reagent.

In accordance with a sixth implementation, a method includes moving a dry reagent cup though a liquid impermeable barrier into a liquid-containing liquid reservoir to rehydrate dry reagent and form liquid reagent. The dry reagent cup contains the dry reagent and has a cup opening facing the liquid impermeable barrier. The dry reagent cup comprises one or more protrusions asymmetrically distributed about the cup opening. The one or more protrusions pierce the liquid impermeable barrier when the dry reagent cup moves through the liquid impermeable barrier.

In further accordance with the foregoing first, second, third, fourth, fifth, and/or sixth implementations, an apparatus and/or method may further comprise any one or more of the following:

In accordance with an implementation, the liquid reservoir contains liquid and the dry reagent cup contains dry reagent.

In accordance with another implementation, the liquid impermeable barrier envelopes the dry reagent cup.

In accordance with another implementation, the dry reagent cup is sized to be positioned within a dimensional envelope of the liquid reservoir.

In accordance with another implementation, the cup side wall includes a distal end having a protrusion.

In accordance with another implementation, the protrusion is an asymmetric protrusion.

In accordance with another implementation, the distal end further includes a flat portion.

In accordance with another implementation, the protrusion extends past the flat portion.

In accordance with another implementation, the cup side wall includes a distal end having a plurality of protrusions.

In accordance with another implementation, the protrusions are asymmetrically distributed about the cup.

In accordance with another implementation, the protrusions are located about a first half of the side wall of the cup, where there are no protrusions located about the second half of the side wall of the cup.

In accordance with another implementation, the side wall of the liquid reservoir includes an alignment protrusion and the dry reagent cup assembly defines a bore that receives the alignment protrusion to align the dry reagent cup relative to the liquid reservoir.

In accordance with another implementation, the alignment protrusion and the bore form a snap-fit connection.

In accordance with another implementation, the apparatus includes a seal disposed between the liquid reservoir and the dry reagent cup assembly.

In accordance with another implementation, the seal forms a hermetic seal between the liquid reservoir and the dry reagent cup assembly.

In accordance with another implementation, the coupling between the liquid reservoir and the dry reagent cup assembly compresses the seal.

In accordance with another implementation, the coupling includes a plurality of snap-fit connections that are spaced about the dry reagent cup assembly.

In accordance with another implementation, the coupling includes adhesive.

In accordance with another implementation, the dry reagent cup assembly further includes an annulus surrounding the dry reagent cup and a plurality of frangible tabs that extend between and couple the annulus and the dry reagent cup.

In accordance with another implementation, the liquid impermeable barrier includes a planar portion and a frustum portion having a radially extending base.

In accordance with another implementation, the frustum portion covers the cup base and the planar portion covers the cup opening.

In accordance with another implementation, the planar portion is coupled to the radially extending base of the frustum portion.

In accordance with another implementation, the dry reagent cup assembly includes a plurality of dry reagent cups including the dry reagent cup that are coupled together and have cup openings that are covered by the liquid impermeable barrier.

In accordance with another implementation, prior to piercing the liquid impermeable barrier, the method includes preventing or substantially preventing ingress of moisture to the dry reagent.

In accordance with another implementation, the method further includes folding a portion of the liquid impermeable barrier about the dry reagent cup.

In accordance with another implementation, the reagent reservoir includes the dry reagent cup and the liquid reservoir and the method includes pressurizing the reagent reservoir to flow the liquid reagent toward a flow cell.

In accordance with another implementation, the system further includes an actuator assembly to interface with the dry reagent cup assembly and urge the dry reagent cup to deploy through the liquid impermeable barrier and into the liquid reservoir.

In accordance with another implementation, the cup side wall includes a distal end including a contoured distal end having a longer portion and a shorter portion.

In accordance with another implementation, the side wall of the liquid reservoir includes an alignment protrusion and the annulus defines a bore that receives the alignment protrusion to align the dry reagent cup relative to the liquid reservoir.

In accordance with another implementation, the protrusion includes a scalloped portion.

In accordance with another implementation, the protrusion includes an outward extending bevel.

In accordance with another implementation, prior to moving the dry reagent cup through the liquid impermeable barrier, further including substantially preventing ingress of moisture to the dry reagent.

In accordance with another implementation, moving the dry reagent cup through the liquid impermeable barrier folds a portion of the impermeable barrier about the dry reagent cup.

In accordance with another implementation, a reagent reservoir includes the dry reagent cup and the liquid reservoir. The method also includes pressurizing the reagent reservoir to flow the liquid reagent toward a flow cell.

In accordance with another implementation, each of the one or more protrusions is an asymmetrical protrusion.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a schematic diagram of another implementation of the system of FIG. 1.

FIG. 3 is a schematic diagram of another implementation of the reagent cartridge that can be used with the system of FIGS. 1 and/or 2.

FIG. 4 is a schematic diagram of an implementation of the liquid reservoir and the dry reagent cup assembly that can be used with the systems of FIGS. 1 and/or 2 and/or the reagent cartridge of FIG. 3.

FIG. 5 is a schematic diagram of an implementation of the dry reagent cup assembly that can be used with the systems of FIGS. 1 and/or 2, the reagent cartridge of FIG. 3, and/or the dry reagent cup assembly of FIG. 4.

FIG. 6 is a plan view of an implementation of a reagent cartridge that can be used to implement the systems of FIGS. 1 and/or 2 and/or the reagent cartridge of FIG. 3.

FIG. 7 is a cross-sectional schematic diagram of an implementation of the liquid reservoir and the dry reagent cup assembly that may be used to implement the systems of FIGS. 1 and/or 2 and/or the reagent cartridge of FIGS. 3 and/or 6.

FIG. 8 is a cross-sectional schematic diagram of an implementation of the dry reagent cup assembly that may be used to implement the systems of FIGS. 1 and/or 2, the reagent cartridge of FIGS. 3 and/or 6, and/or the dry reagent cup assembly of FIG. 7.

FIG. 9 is an isometric partial view of an implementation of the dry reagent cup that may be used to implement the dry reagent cup assemblies disclosed.

FIG. 10 is an isometric view of an implementation of the dry reagent cup assembly that includes a plurality of dry reagent cups having cup openings and a liquid impermeable barrier covering the cup opening.

FIG. 11 is a cross-sectional view of another implementation of the reagent reservoir including the liquid reservoir and the dry reagent cup assembly.

FIG. 12 is an isometric cross-sectional view of another reagent reservoir including the liquid reservoir and the dry reagent cup assembly.

FIG. 13 illustrates a flowchart for a method of rehydrating dry reagent using the system of FIG. 1 or any of the other implementations disclosed herein.

FIG. 14 illustrates another flowchart for a method of rehydrating dry reagent using the system of FIG. 1 or any of the other implementations disclosed herein.

FIG. 15 illustrates another flowchart for a method of rehydrating dry reagent using the system of FIG. 1 or any of the other implementations disclosed herein.

FIG. 16 illustrates another flowchart for a method of rehydrating dry reagent using the system of FIG. 1 or any of the other implementations disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is directed toward reagent cartridges including one or more two-part reagent reservoirs. These two-part reagent reservoirs include a liquid reservoir containing liquid and a dry reagent cup assembly including a dry reagent cup containing dry reagent. The dry reagent cup is coaxial or otherwise aligned with an opening of the liquid reservoir to allow the dry reagent cup to be received within a dimensional envelope of the liquid reservoir when rehydrating the dry reagent. Thus, the dry reagent cup may be fully received and immersed within the liquid of the liquid reservoir. A liquid impermeable barrier separates the dry reagent cup and the liquid reservoir and may include foil. The liquid impermeable barrier may also encapsulate the dry reagent cup during shipping and/or storage to prevent or at least substantially prevent moisture ingress and the dry reagent from being inadvertently rehydrated.

To rehydrate the dry reagent and form a liquid reagent, the dry reagent cup is urged or displaced to pierce the liquid impermeable barrier and allow the dry reagent cup to pass through the liquid impermeable barrier and be received within the liquid reservoir below. The dry reagent cup may include a distal end having an asymmetric protrusion and a flat portion, where the asymmetric protrusion pierces the liquid impermeable barrier and the flat portion acts as a fulcrum that folds the liquid impermeable barrier about the dry reagent cup. In some implementations, the asymmetric protrusion may include a plurality of sub-protrusions that are evenly or unevenly distributed. Having the dry reagent cup fold the liquid impermeable barrier in this manner reduces the likelihood or may even prevent the liquid impermeable barrier from being “cored.”

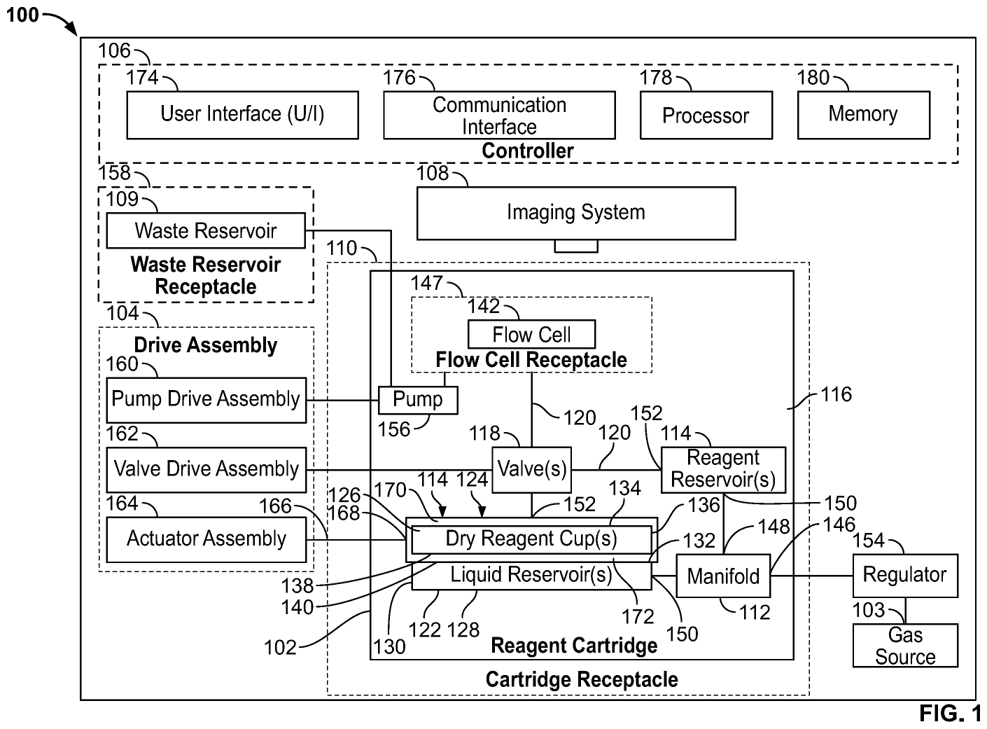

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). In the implementation shown, the system 100 receives a reagent cartridge 102 and includes, in part, a gas source 103, a drive assembly 104, a controller 106, an imaging system 108, and a waste reservoir 109. The controller 106 is electrically and/or communicatively coupled to the drive assembly 104 and to the imaging system 108 and causes the drive assembly 104 and/or the imaging system 108 to perform various functions as disclosed herein.

The reagent cartridge 102 carries the sample of interest. The gas source 103 may, in some implementations, be used to pressurize the reagent cartridge 102 and the drive assembly 104 interfaces with the reagent cartridge 102 to rehydrate dry reagents and to flow one or more liquid reagents (e.g., A, T, G, C nucleotides) through the reagent cartridge 102 that interact with the sample. The gas source 103 may be provided by the system 100 and/or may be carried by the reagent cartridge 102. Alternatively, the gas source 103 may be omitted.

In an implementation, a reversible terminator is attached to the reagent to allow a single nucleotide to be incorporated by the sstDNA per cycle. In some such implementations, one or more of the nucleotides has a unique fluorescent label that emits a color when excited. The color (or absence thereof) is used to detect the corresponding nucleotide. In the implementation shown, the imaging system 108 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 108 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 104 interfaces with the reagent cartridge 102 to flow another reaction component (e.g., a reagent) and/or gas through the reagent cartridge 102 that is thereafter received by the waste reservoir 109 and/or otherwise exhausted by the reagent cartridge 102. In an implementation, the reagent and the gas is alternatingly flowed through the reagent cartridge 102. The reaction component and the gas perform a flushing operation that chemically cleaves the fluorescent label and the reversible terminator from the sstDNA. The sstDNA is then ready for another cycle.

Referring to the reagent cartridge 102, in the implementation shown, the reagent cartridge 102 is receivable within a cartridge receptacle 110 of the system 100 and includes a manifold 112, reagent reservoirs 114, a body 116, one or more valves 118, and fluidic lines 120. In other implementations, the reagent cartridge 102 does not include the manifold 112. The reagent reservoirs 114 may contain fluid (e.g., reagent and/or another reaction component) and the valves 118 may be selectively actuatable to control the flow of fluid through the fluidic lines 120. One or more of the valves 118 may be implemented by a rotary valve, a pinch valve, a flat valve, a solenoid valve, a check valve, a piezo valve, etc. The body 116 may be formed of solid plastic using injection molding techniques and/or additive manufacturing techniques. In some implementations, the reagent reservoirs 114 are integrally formed with the body 116. In other implementations, the reagent reservoirs 114 are separately formed and coupled to the body 116. The reagent reservoirs 114 and/or the reagent cartridge 102 may include polypropylene and/or cyclic olefin copolymer (COC) with an over molded Santoprene thermoplastic elastomer (TPE) or another thermoplastic elastomer. Other materials may prove suitable for the reagent reservoirs 114 and/or the reagent cartridge 102.

In the implementation shown, one or more of the reagent reservoirs 114 include a liquid reservoir 122 and a dry reagent cup assembly 124 coupled to the liquid reservoir 122 and including a dry reagent cup 126. The liquid reservoir 122 and/or the dry reagent cup 126 may be considered modular components. The coupling between the liquid reservoir 122 and the assembly 124 may self-align the cup 126 with the liquid reservoir 122. In this manner, the cup 126 is aligned to be moved into the liquid reservoir 122 as further discussed below.

The liquid reservoir 122 may contain a liquid such as a buffer or water and the cup 126 may contain a lyophilized reagent (e.g., freeze-dried reagent). The liquid reservoir 122 may be filled with liquid prior to shipping or may be filled by an individual and/or the system 100 prior to use. Because the cup 126 houses the dry reagent and not liquid reagent, the assembly 124 may be ambient shipped and/or stored. Such an approach may simplify storage requirements, reduce shipping costs, and increase the speed of workflows by, for example, avoiding thaw time before the reagent may be used. While the liquid reservoir 122 is mentioned housing liquid and the cup 126 is mentioned housing dry reagent, the liquid reservoir 122 and/or the cup 126 may contain another substance(s) (e.g., solids and/or liquids).

The liquid reservoir 122 has a base 128, a side wall 130 that extends from the base 128, and a distal opening 132. Similarly, the cup 126 has a cup base 134, a cup side wall 136 that extends from the cup base 134, and a cup opening 138. The cup base 134 may be integral to the cup 126 or may include foil or another material. In some implementations, the cup base 134 is flat and can support the cup 126 on a surface when the cup 126 is being filled with liquid reagent and freeze-dried.

The distal opening 132 of the liquid reservoir 122 faces the cup opening 138 and a liquid impermeable barrier 140 covers the cup opening 138 and separates the liquid reservoir 122 and the cup 126. The barrier 140 reduces the likelihood and may even prevent dry reagent contained within the cup 126 from being inadvertently rehydrated, or at least reduces the rate at which the dry reagent contained within the cup 126 is rehydrated, via the ingress of moisture. In some implementations, the barrier 140 may envelope or partially envelope the cup 126. As such, the barrier 140 may be disposed on both sides of the cup 126 as shown in the implementations disclosed below. The barrier 140 may be a thin metal foil, such as aluminum foil, or a thin plastic sheet(s), such as Saran™ wrap. In an implementation, the barrier 140 is five heat-sealed aluminized foils. However, the barrier 140 may comprise or consist of other materials and/or other layering arrangements that substantially prevent moisture ingress into the dry reagent.

To rehydrate the dry reagent, the cup 126 is movable between an initial position outside of the liquid reservoir 122 (shown) and a rehydrating position disposed within the liquid reservoir 122. To move the cup 126 into the rehydrating position, the cup 126 is mechanically actuated to pierce and pass through an opening in the barrier 140. Advantageously, the cup 126 may, on-demand, substantially simultaneously pierce the barrier 140 and deploy dry reagent into the liquid of the liquid reservoir 122 to rehydrate and functionalize the reagent. In the rehydrating position, the cup 126 may be positioned within a dimensional envelope of the liquid reservoir 122. Fully positioning the cup 126 within the liquid reservoir 122 may encourage all of the reagent to be rehydrated, whereas if the cup 126 was not fully or substantially submerged within the liquid reservoir 122, small amounts of the dry reagent may have a tendency to remain coupled to the inside of the cup 126.

Referring now to the manifold 112, the manifold 112 is fluidically coupled to the gas source 103, one or more of the reagent reservoirs 114, and the valve 118. The coupling between the components 103, 112, 114, 116 allows gas (e.g., air) to pressurize the reagent cartridge 102 by flowing gas through the manifold 112 to the reagent reservoirs 114 and to the valve 118. The gas source 103 may pressurize the reagent to flow the reagent through the fluidic lines 120 under positive pressure, which increases the flow rate through the reagent cartridge 102 and/or decreases a response time to flow the reagent into, for example, a flow cell 142 and, more generally, reduces cycle times of the system 100. Alternatively, one or more of the reagent reservoirs 114 may not be pressurized.

The manifold 112 includes an inlet 146 fluidically coupled to the gas source 103 and outlets 148 fluidically coupled to the valve 118 via the reagent reservoirs 114. In the implementation shown, one of the manifold outlets 148 may be fluidically coupled to an inlet 150 of the reagent reservoir 114 such that the manifold 112 is coupled to the valve 118 via the reagent reservoir 114. The reagent reservoir 114 also includes an outlet 152 fluidically coupled to the valve 118. The manifold 112 may alternatively be directly coupled to the valve 118 by the fluidic line 120. Other arrangements may prove suitable.

A regulator 154 can be positioned between the gas source 103 and the manifold 112 and regulates a pressure of the gas provided to the manifold 112. Alternatively, the regulator 154 may not be included. The regulator 154 may be implemented by a multi-channel regulator. In an implementation, the pressure applied to, for example, the reagent reservoir 114, is determined by calibrating a flow rate in the reagent cartridge 102 to a pressure of the gas source 103. However, the pressure may be selected in different ways. Alternatively, one or more regulators 154 may be positioned between the manifold 112 and the reagent reservoir 114 and/or between the manifold 112 and the valve 118.

The reagent cartridge 102 is in fluid communication with the flow cell 142. In the implementation shown, the flow cell 142 is carried by the reagent cartridge 102 and is received via a flow cell receptacle 147. Alternatively, the flow cell 142 can be integrated into the reagent cartridge 102. In such implementations, the flow cell receptacle 147 may not be included or, at least, the flow cell 142 may not be removably receivable within the reagent cartridge 102. As a further alternative, the flow cell 142 may be separate from the reagent cartridge 102.

While the above disclosure describes urging reagent through the flow cell 142 under positive pressure, reagent may alternatively be drawn through the flow cell 142 under negative pressure when, for example, the reagent reservoirs 114 are not pressurized. To do so, the reagent cartridge 102 may include a pump 156 positioned between the flow cell 142 and the waste reservoir 109. The waste reservoir 109 may be selectively receivable within a waste reservoir receptacle 158 of the system 100. The pump 156 may be implemented by a syringe pump, a peristaltic pump, a diaphragm pump, etc. While the pump 156 may be positioned between the flow cell 142 and the waste reservoir 109, in other implementations, the pump 156 may be positioned upstream of the flow cell 142 or omitted entirely.

Referring now to the drive assembly 104, in the implementation shown, the drive assembly 104 includes a pump drive assembly 160, a valve drive assembly 162, and an actuator assembly 164. The pump drive assembly 160 interfaces with the pump 156 to pump fluid through the reagent cartridge 102 and the valve drive assembly 162 interfaces with the valve 118 to control the position of the valve 118. The actuator assembly 164 interfaces with the dry reagent cup assembly 124 and urges the cup 126 to deploy through the barrier 140 and into the liquid reservoir 122. As an example, the actuator assembly 164 includes a rod 166 having a distal end 168 that engages the cup base 134, via an upper barrier portion 170, and moves the cup 126 through a lower barrier portion 172 and into the liquid reservoir 122 below. The actuator assembly 164 may include a linear actuator, the upper barrier portion 170 may be cold form foil, and/or the lower barrier portion 172 may be pierceable foil.

Referring to the controller 106, in the implementation shown, the controller 106 includes a user interface 174, a communication interface 176, one or more processors 178, and a memory 180 storing instructions executable by the one or more processors 178 to perform various functions including the disclosed implementations. The user interface 174, the communication interface 176, and the memory 180 are electrically and/or communicatively coupled to the one or more processors 178.

In an implementation, the user interface 174 receives input from a user and provides information to the user associated with the operation of the system 100 and/or an analysis taking place. The user interface 174 may include a touch screen, a display, a key board, a speaker(s), a mouse, a track ball, and/or a voice recognition system. The touch screen and/or the display may display a graphical user interface (GUI).

In an implementation, the communication interface 176 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 178 and/or the system 100 may include one or more of a processor-based system(s) or a microprocessor-based system(s). In some implementations, the one or more processors 178 and/or the system 100 includes a reduced-instruction set computer(s) (RISC), an application specific integrated circuit(s) (ASICs), a field programable gate array(s) (FPGAs), a field programable logic device(s) (FPLD(s)), a logic circuit(s), and/or another logic-based device executing various functions including the ones described herein.

The memory 180 can include one or more of a hard disk drive, a flash memory, a read-only memory (ROM), erasable programable read-only memory (EPROM), electrically erasable programable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

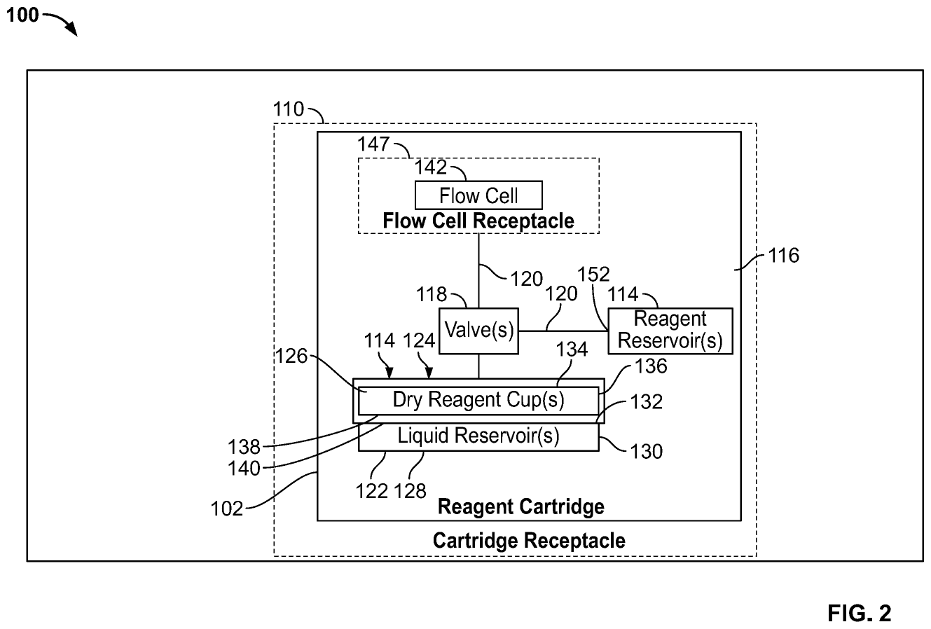

FIG. 2 is a schematic diagram of another implementation of the system 100 of FIG. 1. In the implementation of FIG. 2, the system 100 includes the cartridge receptacle 110. FIG. 2 also shows the reagent cartridge 102 and the flow cell 142. As with the reagent cartridge 102 of FIG. 1, the reagent cartridge 102 of FIG. 2 includes the plurality of reagent reservoirs 114, where one or more of the reagent reservoirs 114 include the liquid reservoir 122 and the assembly 124 coupled to the liquid reservoir 122 and including the cup 126.

The liquid reservoir 122 has the base 128, the side wall 130 that extends from the base 128, and the distal opening 132. Similarly, the cup 126 has the cup base 134, the cup side wall 136 that extends from the cup base 134, and the cup opening 138. The distal opening 132 of the liquid reservoir 122 faces the cup opening 138 and the barrier 140 covers the cup opening 138 and separates the liquid reservoir 122 and the cup 126. To rehydrate the dry reagent, the cup 126 is movable between an initial position outside of the liquid reservoir 122 (shown) and a rehydrating position where the cup 126 pierces and passes through an opening in the barrier 140 and is received within the liquid reservoir 122.

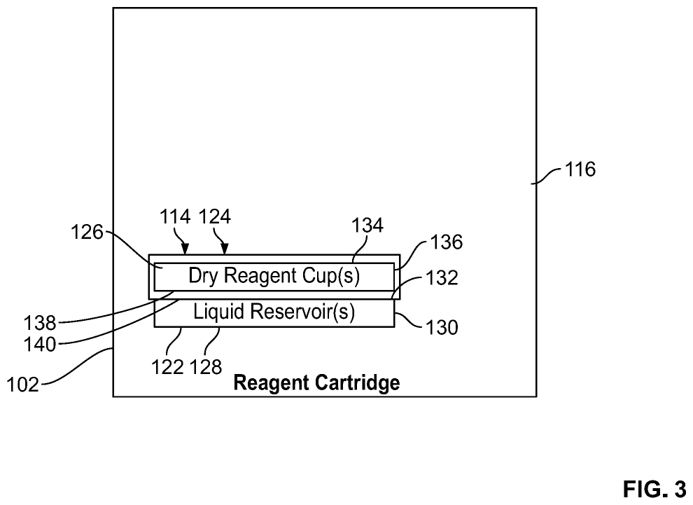

FIG. 3 is a schematic diagram of another implementation of the reagent cartridge 102 that can be used with the system 100 of FIGS. 1 and/or 2. In the implementation shown, the reagent cartridge 102 includes the liquid reservoir 122 and the assembly 124 coupled to the liquid reservoir 122 and including the cup 126.

The liquid reservoir 122 has the base 128, the side wall 130 that extends from the base 128, and the distal opening 132. Similarly, the cup 126 has the cup base 134, the cup side wall 136 that extends from the cup base 134, and the cup opening 138. The distal opening 132 of the liquid reservoir 122 faces the cup opening 138 and the barrier 140 covers the cup opening 138 and separates the liquid reservoir 122 and the cup 126. To rehydrate the dry reagent, the cup 126 is movable between an initial position outside of the liquid reservoir 122 (shown) and a rehydrating position where the cup 126 pierces and passes through an opening in the barrier 140 and is received within the liquid reservoir 122.

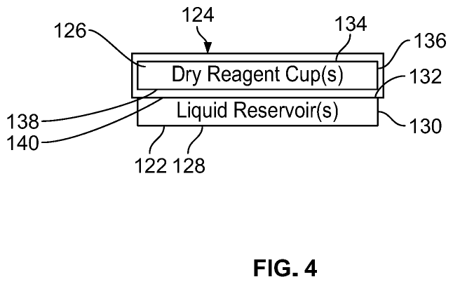

FIG. 4 is a schematic diagram of an implementation of the liquid reservoir 122 and the assembly 124 that can be used with the systems 100 of FIGS. 1 and/or 2 and/or the reagent cartridge 102 of FIG. 3. In the implementation shown, the assembly 124 is coupled to the liquid reservoir 122 and includes the cup 126 and the barrier 140 covers the cup opening 138 and separates the liquid reservoir 122 and the cup 126. To rehydrate the dry reagent, the cup 126 is movable between an initial position outside of the liquid reservoir 122 (shown) and a rehydrating position where the cup 126 pierces and passes through an opening in the barrier 140 and is received within the liquid reservoir 122.

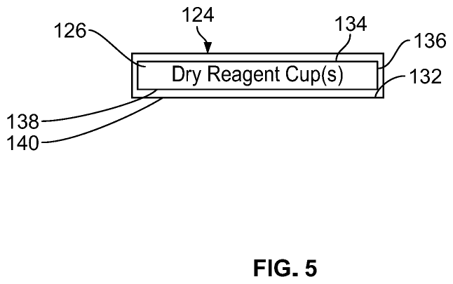

FIG. 5 is a schematic diagram of an implementation of the assembly 124 that can be used with the systems 100 of FIGS. 1 and/or 2, the reagent cartridge 102 of FIG. 3, and/or the assembly 124 of FIG. 4. In the implementation shown, the assembly 124 includes the cup 126 and the barrier 140 covers the cup opening 138. To rehydrate the dry reagent, the cup 126 is movable to pierce the barrier 140 and allow the cup 126 to pass through the liquid reservoir 122.

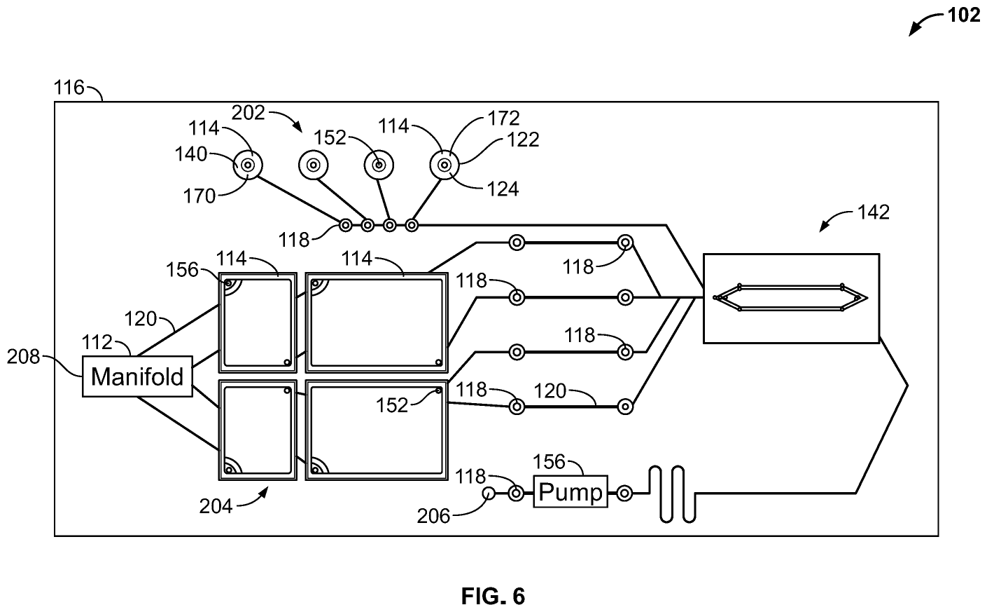

FIG. 6 is a plan view of an implementation of the reagent cartridge 102 that can be used to implement the systems 100 of FIGS. 1 and/or 2 and/or the reagent cartridge 102 of FIG. 3. In the implementation shown, the reagent cartridge 102 carries the flow cell 142 and includes the body 116, the manifold 112, the reagent reservoirs 114, the valves 118, and the pump 156, which are fluidically coupled via the fluidic lines 120. The reagent reservoirs 114 may be integrally formed with the body 116 or may be separately formed but coupled to the body 116.

In the implementation shown, the reagent reservoirs 114 include a first plurality of reagent reservoirs 202 and a second plurality of reagent reservoirs 204, where both the first and second reagent reservoirs 202, 204 are fluidically coupled to the flow cell 142 but only the second reagent reservoirs 204 are fluidically coupled to the manifold 112. However, in other implementations, the first reagent reservoirs 202 may be fluidically coupled to the manifold 112. Other coupling arrangements may prove suitable. The first reagent reservoirs 202 may include dry reagent and the second reagent reservoirs 204 may include liquid reagent. Thus, the reagent cartridge 102 may include both dry reagent and liquid reagent.

Each of the first reagent reservoirs 202 includes the liquid reservoir 122 and the assembly 124 and are fluidically coupled to the pump 156. The liquid reservoirs 122 may have a volume of liquid that is used to rehydrate the reagent of the associated assembly 124. Similarly, the assembly 124 may be sized to carry an amount of dry reagent associated with the various functions as disclosed herein. As an example, one of the cups 126 may be a first size and another of the cups 126 may be a second size, where the first size is different than the second size. Correspondingly, one of the liquid reservoirs 122 may be larger than another of the liquid reservoirs 122. Thus, the first reagent reservoirs 202 are scalable and may be different sizes from one another depending on the volume of liquid used to rehydrate the dry reagent and the amount of reagent used to perform a particular task. In another example, one of the cups may be the same size as another of the cups, and the corresponding liquid reservoirs may be the same size as each other, or the liquid reservoirs may be of different sizes.

To rehydrate the dry reagent contained within the cup 126, the upper barrier portion 170 may be pressed toward the body 116 of the reagent cartridge 102 to urge the cup 126 through the lower barrier portion 172 and into the liquid reservoir 122. The dry reagent cup 126 may be urged into the liquid reservoir 122 by the actuator assembly 164 of the system 100 and/or in other ways. For example, a user may push the cup 126 into the liquid reservoir 122 using their thumb. However, other approaches of deploying the cup 126 may prove suitable.

Once the reagent is rehydrated, the pump 156 may draw reagent from the respective liquid reservoirs 122 under negative pressure to an outlet 206 associated with the waste reservoir 109. The valves 118 disposed on either side of the pump 156 may be check valves to reduce or prevent backwash flow when operating the pump 156. In other implementations, the valves 118 on either side of the pump 156 may be omitted.

The manifold 112 includes an interface 208 that fluidically couples with the gas source 103 of the system 100 to pressurize the second reagent reservoirs 204 and to flow any fluid therein toward the flow cell 142 under positive pressure when corresponding valves 118 are opened. When one or more of the second reagent reservoirs 204 are empty (e.g., do not substantially contain reagent or another reaction component), gas can flow through the empty second reagent reservoir(s) 204 through the flow cell 142 to the outlet 206.

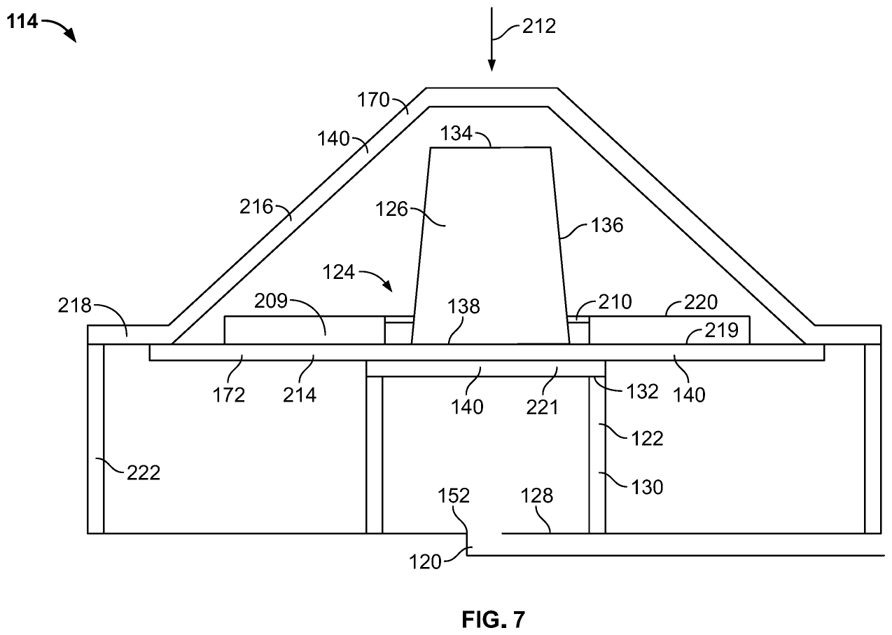

FIG. 7 is a cross-sectional schematic diagram of an implementation of the liquid reservoir 122 and the dry reagent cup assembly 124 that may be used to implement the systems 100 of FIGS. 1 and/or 2 and/or the reagent cartridge 102 of FIGS. 3 and/or 6. In the implementation shown, the assembly 124 includes an annulus 209 and a plurality of frangible tabs 210 that extend between and couple the annulus 209 and the cup 126. The frangible tabs 210 secure the cup 126 relative to the annulus 209 and break to release the cup 126 when a force is applied to the cup 126, via the upper barrier portion 170, in a direction generally indicated by arrow 212. Four tabs 210 may be provided that are spaced about 90° relative to one another around the cup 126. However, another number of tabs 210 and/or a spacing arrangement may prove suitable. In another implementation, the tabs may be omitted.

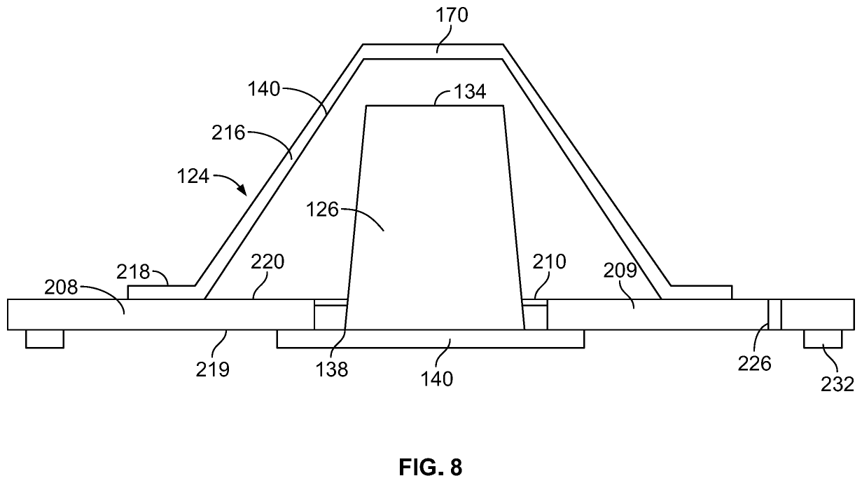

The illustrated implementation shows the lower barrier portion 172 being a planer portion 214 that covers the cup opening 138 and the upper barrier portion 170 being a frustum portion 216 that covers the cup 126 and has a radially extending barrier base 218 that is coupled to the lower barrier portion 172. The frustum portion 216 and the planar portion 214 may be coupled together. For example, the portions may be coupled together by heat sealing. In another example, an adhesive is used to couple the portions together. The frustum portion 216 and the planar portion 214 may be coupled together such that the cup 126 is enveloped by the barrier 140 and the dry reagent therein is protected against being inadvertently hydrated. As an alternative, the planar portion 214 and the barrier base 218 may be coupled to lower and upper surfaces 219, 220 of the annulus 209 via, for example, adhesive, without being directly coupled together (see, for example, FIG. 8).

Referring to the liquid reservoir 122, in the implementation shown, the liquid reservoir 122 includes a second liquid impermeable barrier 221 that covers the distal opening 132 of the liquid reservoir 122. The second barrier 221 prevents or at least substantially prevents liquid within the liquid reservoir 122 from leaking and allows the dry reagent cup assembly 124 to be shipped separately from the liquid reservoir 122, for example.

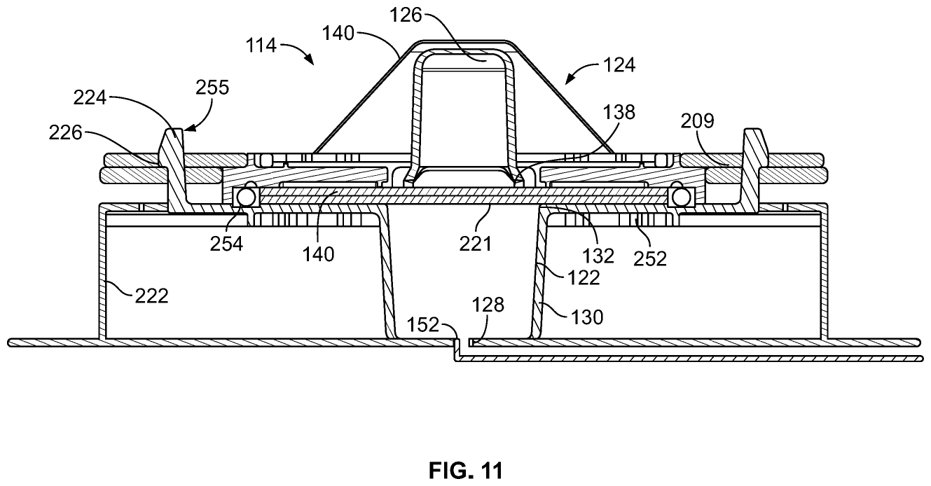

The liquid reservoir 122 also includes a second side wall 222 that is concentric with the side wall 130 and is coupled to the barrier base 218 via, for example, adhesive. The coupling between the second side wall 222 and the barrier base 218 may ease alignment/coupling between the liquid reservoir 122 and the assembly 124. In other implementations, the annulus 209 may be coupled to the second side wall 222 or the second side wall 222 may be omitted. In implementations in which the annulus 209 is coupled to the second side wall 222, the second side wall 222 may include an alignment protrusion 224 (see, FIG. 11) and the annulus 209 may define a bore 226 (see, for example, FIG. 8) that receives the alignment protrusion 224 to align the cup 126 and the assembly 124 relative to the liquid reservoir 122. The alignment protrusion 224 may be cylindrical or may be another shape that, for example, forms a snap-fit connection with the annulus 209. The alignment protrusion 224 and the bore 226 interact to allow the cup 126 to self-align relative to the distal opening 132 of the liquid reservoir 122. In some implementations, an individual and/or the system 100 aligns the liquid reservoir 122 and the assembly 124 relative to one another.

FIG. 8 is a cross-sectional schematic diagram of an implementation of the dry reagent cup assembly 124 that may be used to implement the systems 100 of FIGS. 1 and/or 2, the reagent cartridge 102 of FIGS. 3 and/or 6, and/or the assembly 124 of FIG. 7. The assembly 124 of FIG. 8 is similar to the assembly 124 of FIG. 7. However, in contrast, the barrier base 218 is coupled to the upper side 220 of the annulus 209 and the planar portion 214 is coupled to the lower side 219 of the annulus 209. Adhesive 232 is also provided on the lower side 219 of the annulus 209 to facilitate coupling the assembly 124 to the liquid reservoir 122.

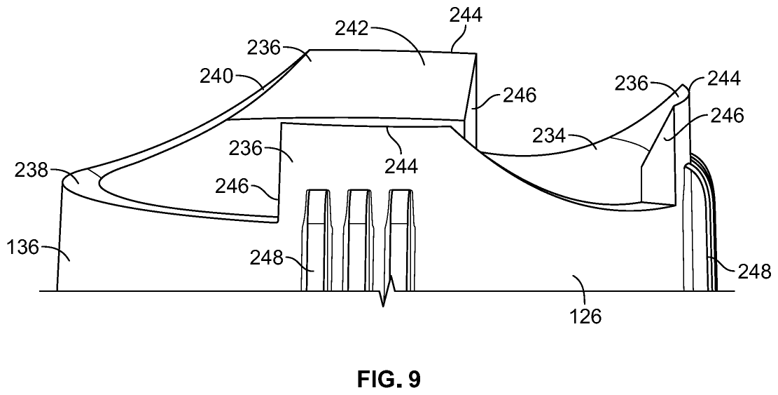

FIG. 9 is an isometric partial view of an implementation of the cup 126 that may be used to implement the dry reagent cup assemblies 124 disclosed. In the implementation shown, the cup side wall 136 includes a distal end 234 having a plurality of protrusions 236 and a flat portion 238, where the protrusions 236 extend past the flat portion 238 such that the protrusions 236 form a longer portion of the cup 126 relative to a shorter portion of the cup 126 formed by the flat portion 238. The flat portion 238 may include a filleted round inner edge and may act as a fulcrum for the cut barrier 140 to fold over. However, the flat portion 238 may alternatively be rounded, have a rounded portion (e.g., inner or outer edge), or have another contour.

The protrusions 236 are shown being biased or otherwise not evenly spaced about the cup 126. In other words, the protrusions 236 are asymmetrically distributed about the cup 126. In some implementations, the protrusions 236 are located about half of the cup 126, with the flat portion 238 located about the other half of the cup 126. Biasing the protrusions 236 as shown in FIG. 9 allows the protrusions 236 to pierce and form an arced opening through the barrier 140 without coring the barrier 140. In the implementation shown, the protrusions 236 are asymmetric and include a contoured portion 240, an outward extending bevel 242 that forms a sector edge 244, and vertical portions 246 that connect the protrusions 236 and the flat portion 238. While the cup 126 includes three protrusions 236 that have a trapezoidal shape and form scalloped portions about some of a circumference of the cup 126, the cup 126 may include another number of protrusions (e.g., 1 protrusion, 2 protrusions, 4 protrusions). The cup 126 may also include exterior ribs 248 that may be used to deter the barrier 140 from coring. The ribs 248 may outwardly taper from the distal end 234 of the cup 126 or the ribs 248 may have a consistent radial width. While groupings of three ribs 248 are shown, any number of ribs 248 may be grouped together (e.g., 1, 2, 3) or the ribs 248 may be omitted.

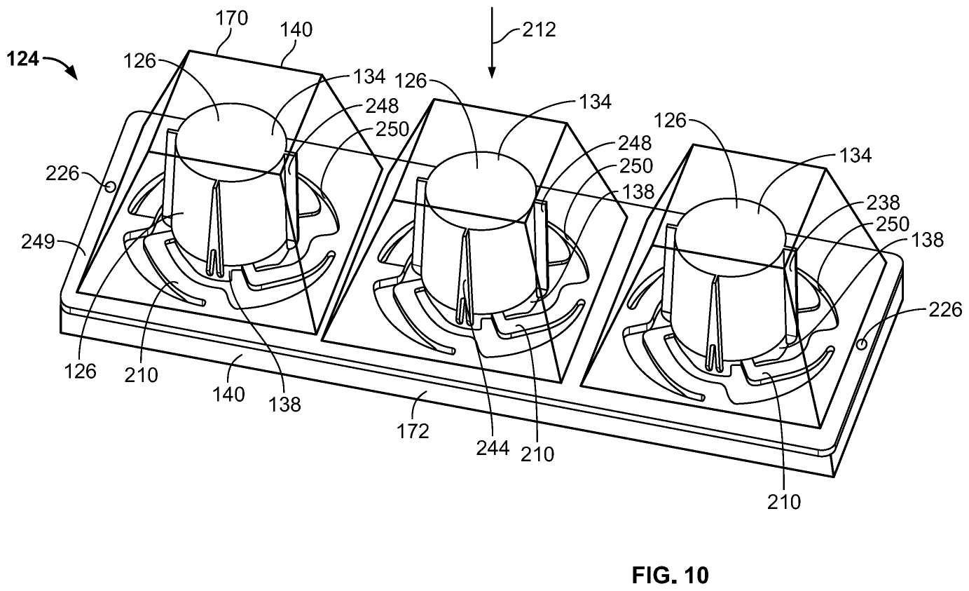

FIG. 10 is an isometric view of an implementation of the dry reagent cup assembly 124 that includes a plurality of the dry reagent cups 126 having the cup openings 138 and the liquid impermeable barrier 140 covering the cup openings 138. The reagent cups 126 of FIG. 10 may be referred to as an array. As with the implementations disclosed above, the lower barrier portion 172 covers the cup opening 138 and the upper barrier portion 170 covers the cup base 134. The barrier portions 170, 172 may be coupled to one another and/or may be coupled to a panel 249.

The panel 249 defines a plurality of through-holes 250 that correspond to the cups 126 and the tabs 210 connect the cups 126 and the panel 249 at the respective cup openings 138. The panel 249 also includes the bores 226 to allow the assembly 124 to be easily aligned and coupled to the liquid reservoirs 122. As with the frangible tabs 210 of the assembly 124 of FIGS. 7 and 8, applying a force to a corresponding cup 126 in a direction generally indicated by arrow 212 breaks the frangible tabs 210 and moves the cup 126 through the lower barrier portion 172.

In the implementation shown, the tabs 210 are arc-shaped. However, the tabs 210 may alternatively radially extend between the panel 249 and the cup 126. Additionally, in the implementation shown, the ribs 248 are v-shaped. However, the ribs 248 may be a different shape or may be omitted.

FIG. 11 is a cross-sectional view of another implementation of the reagent reservoir 114 including the liquid reservoir 122 and the dry reagent assembly 124. The liquid reservoir 122 and the assembly 124 of FIG. 11 are similar to the liquid reservoir 122 and the assembly 124 of FIGS. 7 and 8. However, in contrast, the liquid reservoir 122 includes a radial wall 252 that extends between the walls 130 and 222. Additionally, a seal 254 is positioned between the radial wall 252 and the annulus 209. The seal 254 may be a thermoplastic elastomer (TPE) ring and may be received within a seal groove defined by one of the annulus 209 and/or the radial wall 252. Additionally or alternatively, the radial wall 252 may include overmolded thermoplastic elastomer to provide a hermetic seal when the assembly 124 is coupled to the liquid reservoir 122. In the implementation shown, the alignment protrusion 224 and the bore 226 form a snap fit connection 255 that applies a positive pressure to compress the seal 254 and form a hermetic seal between the liquid reservoir 122 and the assembly 124. The seal 254 and the hermetic seal formed thereby may enable reagent to be pumped through the system 100 under positive pressure. In some implementations, there are four snap fit connections 255 between the liquid reservoir 122 and the assembly 124 that allow the cup 126 to self-align relative to the liquid reservoir 122.

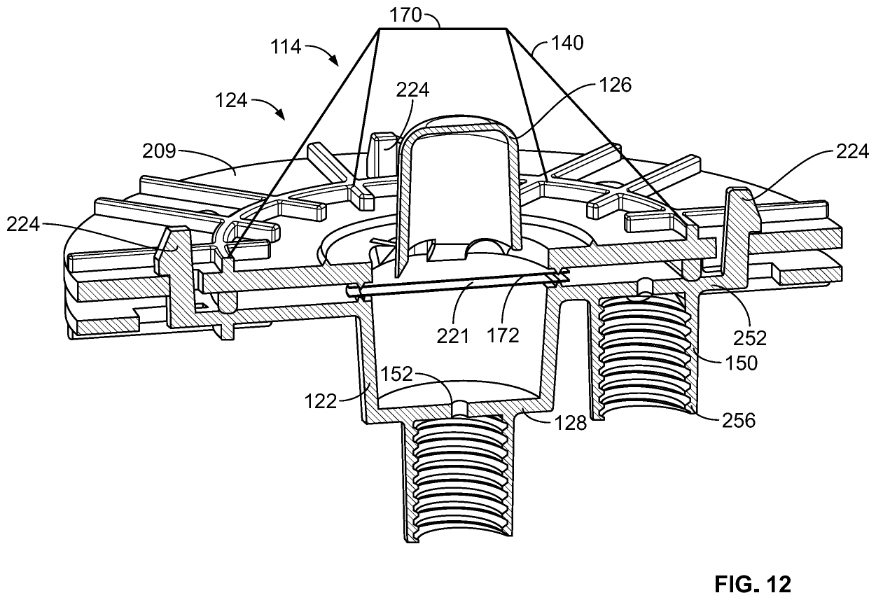

FIG. 12 is an isometric cross-sectional view of another reagent reservoir 114 including the liquid reservoir 122 and the dry reagent cup assembly 124. The assembly 124 of FIG. 12 is the same or substantially the same as the assembly 124 of FIG. 11 and the liquid reservoir 122 of FIG. 12 is similar to the liquid reservoir 122 of FIG. 11. However, in contrast to the liquid reservoir 12 of FIG. 11, the liquid reservoir 122 of FIG. 12 does not include the second side wall 222 but does include the inlet 150 to allow the reagent reservoir 114 to be fluidically coupled to the manifold 112. The gas source 103 may pressurize the liquid reservoir 122 after the cup 126 passes through the barrier portions 172, 221 and forms an opening. The outlet 152 of the liquid reservoir 122 of FIG. 12 also includes a threaded port 256.

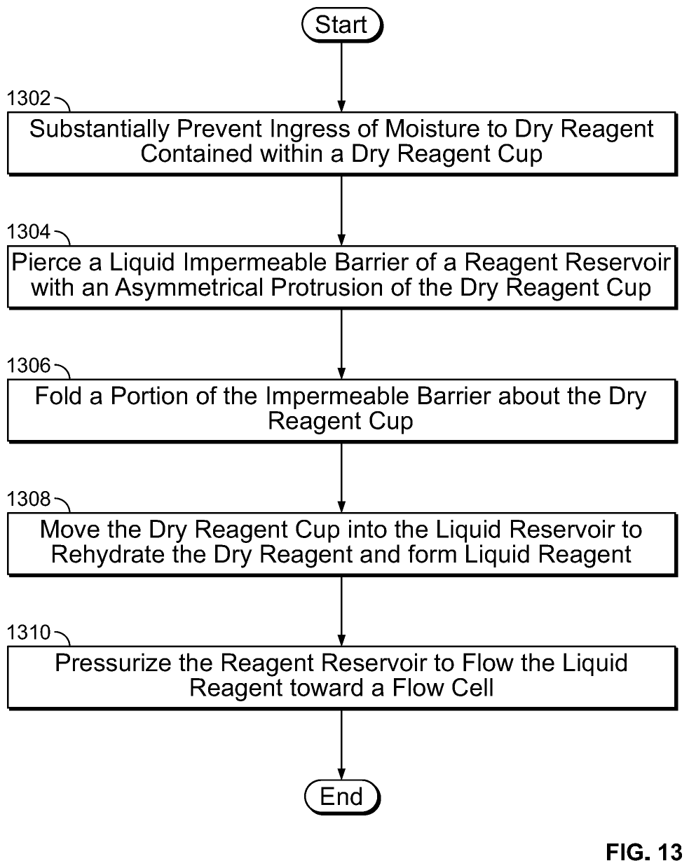

FIGS. 13, 14, 15, and 16 illustrate flowcharts for methods of rehydrating dry reagent using the system 100 of FIG. 1, the reagent reservoirs 114, the liquid reservoir 122 and the dry reagent cup assembly 124, the first reagent reservoirs 202, or any of the other implementations disclosed herein. The order of execution of the blocks may be changed, and/or some of the blocks described may be changed, eliminated, combined and/or subdivided into multiple blocks.

The process of FIG. 13 begins with substantially preventing ingress of moisture to dry reagent within the cup 126 (block 1302). The barrier 140 may be used to at least substantially prevent the ingress of moisture to the dry reagent by, for example, surrounding or otherwise covering at least portions of the cup 126. The barrier 140 of the reagent cartridge 102 is pierced with an asymmetrical protrusion 236 of the cup 126 (block 1304). The cup 126 contains the dry reagent and has the cup opening 138 that faces the barrier 140 and the opening 132 of the liquid reservoir 122 containing liquid. A portion of the barrier 140 is folded about the cup 126 (block 1306). Folding the portion of the barrier 140 about the cup 126 may prevent the barrier 140 from being “cored” during and/or after the barrier 140 is pierced. The dry reagent cup 126 is moved into the liquid reservoir 122 to rehydrate the dry reagent and form liquid reagent (block 1308). The reagent reservoir 114 may be pressurized to flow the liquid reagent toward a flow cell 142 (block 1310). The gas source 103 may be used to pressurize the reagent reservoir 114.

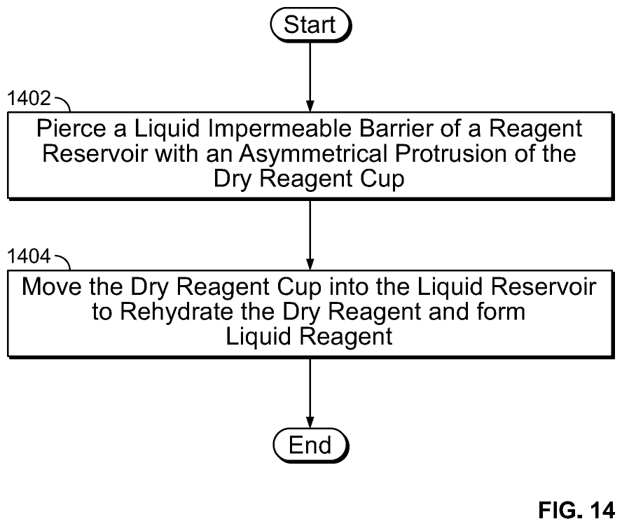

The process of FIG. 14 begins with the barrier 140 of the reagent cartridge 102 being pierced with an asymmetrical protrusion 236 of the cup 126 (block 1402). The cup 126 contains the dry reagent and has the cup opening 138 that faces the barrier 140 and the opening 132 of the liquid reservoir 122 containing liquid. The dry reagent cup 126 is moved into the liquid reservoir 122 to rehydrate the dry reagent and form liquid reagent (block 1404).

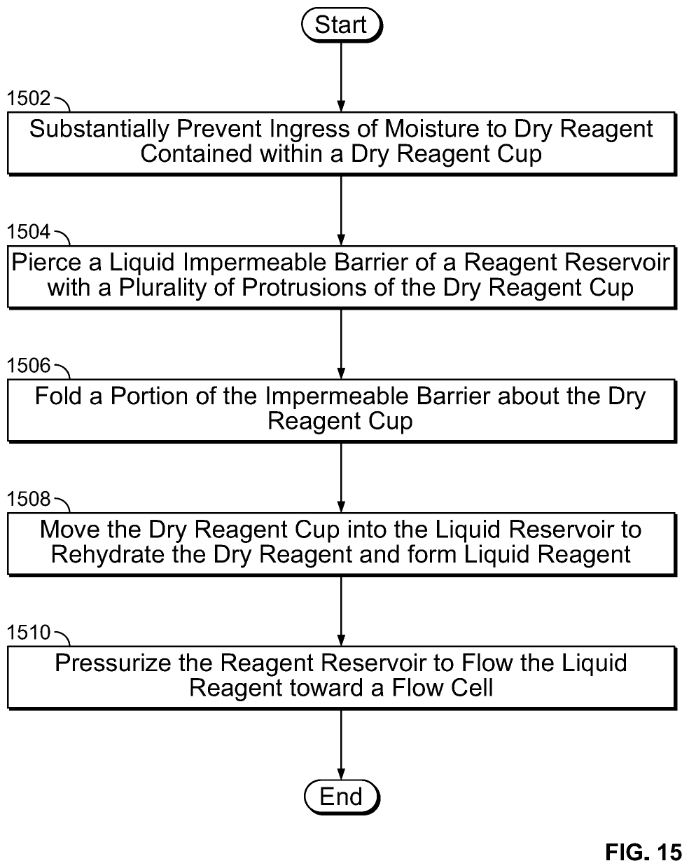

The process of FIG. 15 begins with preventing or at least substantially preventing ingress of moisture to dry reagent within the cup 126 (block 1502). The barrier 140 may be used to prevent or at least substantially prevent the ingress of moisture to the dry reagent by, for example, surrounding or otherwise covering at least portions of the cup 126. The barrier 140 of the reagent cartridge 102 is pierced with the protrusions 236 of the cup 126 (block 1504). The protrusions 236 may be asymmetrically distributed about the cup 126. The cup 126 contains the dry reagent and has the cup opening 138 that faces the barrier 140 and the opening 132 of the liquid reservoir 122 containing liquid. A portion of the barrier 140 is folded about the cup 126 (block 1506). Folding the portion of the barrier 140 about the cup 126 may prevent the barrier 140 from being “cored” during and/or after the barrier 140 is pierced. The dry reagent cup 126 is moved into the liquid reservoir 122 to rehydrate the dry reagent and form liquid reagent (block 1508). The reagent reservoir 114 may be pressurized to flow the liquid reagent toward a flow cell 142 (block 1510). The gas source 103 may be used to pressurize the reagent reservoir 114.

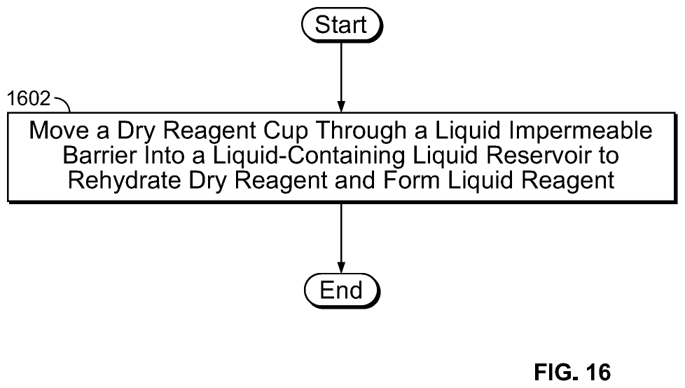

The process of FIG. 16 begins with moving the cup 126 though the barrier 140 into the liquid-containing liquid reservoir 122 to rehydrate the dry reagent and form liquid reagent (block 1602). The cup 126 contains the dry reagent and has the cup opening 132 facing the barrier 140. The cup 140 includes one or more protrusions 238 asymmetrically distributed about the cup opening 132, whereby the one or more protrusions 238 pierce the barrier 140 when the cup 126 is moved through the barrier 140.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a liquid reservoir having a base, a side wall that extends from the base, and a distal opening;
a dry reagent cup assembly coupled to the liquid reservoir and comprising:
a dry reagent cup having a cup base, a cup side wall that extends from the cup base, and a cup opening, the distal opening of the liquid reservoir facing the cup opening; and
a liquid impermeable barrier covering the cup opening and separating the liquid reservoir and the dry reagent cup,
wherein the dry reagent cup is movable between an initial position outside of the liquid reservoir and a rehydrating position where the dry reagent cup pierces and passes through an opening in the liquid impermeable barrier and is received within the liquid reservoir.

2. The apparatus of claim 1, wherein the liquid reservoir contains liquid and the dry reagent cup contains dry reagent.

3. The apparatus of claim 1, wherein the liquid impermeable barrier envelopes the dry reagent cup.

4. The apparatus of claim 1, wherein the dry reagent cup is sized to be positioned within a dimensional envelope of the liquid reservoir.

5. The apparatus of claim 1, wherein the cup side wall includes a distal end having a protrusion.

6. The apparatus of claim 5, wherein the protrusion is an asymmetric protrusion.

7. The apparatus of claim 5, wherein the distal end further includes a flat portion.

8. The apparatus of claim 7, wherein the protrusion extends past the flat portion.

9. The apparatus of claim 1, wherein the cup side wall includes a distal end having a plurality of protrusions.

10. The apparatus of claim 9, wherein the protrusions are asymmetrically distributed about the cup.

11. The apparatus of claim 9, wherein the protrusions are located about a first half of the side wall of the cup, where there are no protrusions located about the second half of the side wall of the cup.

12. The apparatus of claim 1, wherein the side wall of the liquid reservoir comprises an alignment protrusion and the dry reagent cup assembly defines a bore that receives the alignment protrusion to align the dry reagent cup relative to the liquid reservoir.

13. The apparatus of claim 12, wherein the alignment protrusion and the bore form a snap-fit connection.

14. The apparatus of claim 1, further comprising a seal disposed between the liquid reservoir and the dry reagent cup assembly.

15. The apparatus of claim 14, wherein the seal forms a hermetic seal between the liquid reservoir and the dry reagent cup assembly.

16. (canceled)

17. (canceled)

18. (canceled)

19. An apparatus, comprising:
a dry reagent cup assembly, comprising:
a dry reagent cup containing dry reagent and having a cup base and a cup side wall that extends from the cup base, and a cup opening; and
a liquid impermeable barrier covering the cup opening,
wherein the dry reagent cup is movable to pierce the liquid impermeable barrier and allow the dry reagent cup to pass through the liquid impermeable barrier.

20. The apparatus of claim 19, wherein the dry reagent cup assembly further comprises an annulus surrounding the dry reagent cup and a plurality of frangible tabs that extend between and couple the annulus and the dry reagent cup.

21. The apparatus of claim 19, wherein the liquid impermeable barrier comprises a planar portion and a frustum portion having a radially extending base.

22. The apparatus of claim 21, wherein the frustum portion covers the cup base and the planar portion covers the cup opening.

23. The apparatus of claim 21, wherein the planar portion is coupled to the radially extending base of the frustum portion.

24. The apparatus of claim 19, wherein the dry reagent cup assembly includes a plurality of dry reagent cups including the dry reagent cup that are coupled together and have cup openings that are covered by the liquid impermeable barrier.

25. A method, comprising:
piercing a liquid impermeable barrier of a reagent reservoir with an asymmetrical protrusion of a dry reagent cup, the dry reagent cup containing dry reagent and having a cup opening facing the liquid impermeable barrier and an opening of a liquid reservoir containing liquid; and
moving the dry reagent cup into the liquid reservoir to rehydrate the dry reagent and form liquid reagent.

26-37. (canceled)
